(19) United States
(12) Patent Application Publication
(10) Pub. No.: US 2002/0055827 A1
(43) Pub. Date: May 9, 2002

(54) Modeling of head related transfer functions for immersive audio using a state-space approach

(76) Inventor: Chris Kyriakakis, Pasadena, CA (US)

Correspondence Address: HOFFMAN WASSON & GITLER, 2361 JEFFERSON DAVIS HIGHWAY, SUITE 522, ARLINGTON, VA, 22202

(21) Appl. No.: 09/970,705

(22) Filed: Oct. 5, 2001

Related U.S. Application Data
(60) Provisional application No. 60/238,872, filed on Oct. 6, 2000.

(51) Int. Cl. G06F 17/10

(52) U.S. Cl. 703/2

(57) ABSTRACT

Accurate localization of sound in 3-D space is based on variations in the spectrum of sound sources. These variations arise mainly from reflection and diffraction effects caused by the pinnae and are described through a set of Head-Related Transfer Functions (HRTF's) that are unique for each azimuth and elevation angle. A virtual sound source can be rendered in the desired location by filtering with the corresponding HRTF for each ear. In this work, we provide an alternative approach, which uses a multiple-input single-output state-space system to create a combined model of the HRTF's for all directions. This method exploits the similarities among the different HRTF's to achieve a significant reduction in the model size with a minimum loss of accuracy.

This application claims the benefit of U.S. provisional application Serial No. 60/238,872, filed October 6, 2000.

### BACKGROUND OF THE INVENTION

Applications for 3-D sound rendering include teleimmersion; augmented and virtual reality for manufacturing and entertainment; teleconferencing and telepresence; air-traffic control; pilot warning and guidance systems; displays for the visually impaired; distance learning; and professional sound and picturing editing for television and film. Work on sound localization finds its roots as early as the beginning of the twentieth century when Lord Rayleigh first presented the Duplex Theory that emphasized the importance of Interaural Time Differences (ITD) and Interaural Amplitude Differences (LAD) in source localization. It is notable that human listeners can detect ITD's as small as 7 μs which makes it an important cue for localization. Nevertheless, ITD's and IAD's alone are not sufficient to explain localization of sounds in the median plane, in which ITD's and IAD's are both zero.

Variations in the spectrum as a function of azimuth and elevation angles also play a key role in sound localization. These variations arise mainly from reflection and diffraction effects caused by the outer ear (pinna) that give rise to amplitude and phase changes for each angle. These effects are described by a set of functions known as the Head-Related Transfer Functions (HRTF's).

One of the key drawbacks of 3-D audio rendering systems arise from the fact that each listener has HRTF's that are unique for each angle. Measurement of HRTF's is a tedious process that is impractical to perform for every possible angle around the listener. Typically, a relatively small number of angles are measured and various methods are used to generate the HRTF's for an arbitrary angle. Previous work in this area includes modeling using principal component analysis, as well as spatial feature extraction and regulation.

Disclosed is a two-layer method of modeling HRTF's for immersive audio rendering systems. This method allows for two degrees of control over the accuracy of the model. For example, increasing the number of measured HRTF's improves the spatial resolution of the system. On the other hand, increasing the order of the model extracted from each measured HRTF improves the accuracy of the response for each measured direction. Kung's method was used to convert the time-domain representation of HRTF's in state-space form. The models were compared both in their Finite Impulse Response (FIR) filter form and their state-space form. It is clear that the state-space method can achieve greater accuracy with lower order filters. This was also shown using a balanced model truncation method. Although an Infinite Impulse Response (IIR) equivalent of the state-space filter could be used without any theoretical loss of accuracy, it can often lead to numerical errors causing an unstable system, due to the large number of poles in the filter. State-space filters do not suffer as much from the instability problems of IIR filters, but require a larger number of parameters for a filter of the same order. However, considering that there are similarities among the impulse responses for different azimuths and elevations, a combined single system model for all directions can provide, as we will show, a significant reduction.

Previous work on HRTF modeling has mainly focused on methods that attempt to model each direction-specific transformation as a separate transfer function. In this paper we present a method that attempts to provide a single model for the entire 3-D space. The model builds on a generalization of work by Haneda et al, in which the authors proposed a model that shares common poles (but not zeros) for all directions.

### SUMMARY OF THE INVENTION

Our invention uses a multiple-input single-output state space system to create a combined model of the HRTF's for all directions simultaneously. It exploits the similarities among the different HRTF's to achieve a significant reduction in the model size with a minimum loss of accuracy.

### BRIEF DESCRIPTION OF THE DRAWINGS

FIG. 1 is a flow diagram showing how the unprocessed signals are passed to the algorithm along with the desired azimuth and elevation angles of projection;

FIG. 2 is a graphical representation of the delay in samples versus the angle measured related to the ear;

FIG. 3 is a depiction of proposed convention of measuring azimuth in order to have a single delay and gain function for both ears;

FIG. 4 is a graphical representation of the energy is signal versus the angle measured relative to the ear;

FIG. 5 is a frequency domain of measured and simulated impulse responses for a model created with a 30° resolution. θ=40, and θ=50 were not used for the creation of the model;

FIG. 6 is a detail of the time domain of FIG. 5;

FIG. 7 is a model used is reduced down to 191 states from an original size of 600 states. Accuracy has not decreased significantly ; and

FIG. 8 is 12 models of total 192 states. Accuracy has dropped significantly in comparison with FIG. 7 although model size is the same.

### DETAILED DESCRIPTION OF THE INVENTION

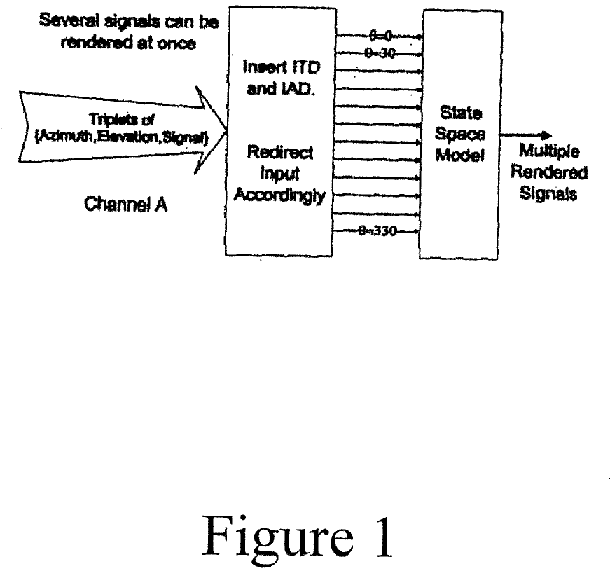

One way to spatially render 3-D sound is to filter a monaural (non-directional) signal with the HRTF's of the desired direction. This involves a single filter per ear for each direction and a selection of the correct filter taps through a lookup table. The main disadvantage of this process is that only one direction can be rendered at a time and interpolation can be problematic. In our method, we extract the important cues of ITD and IAD as a separate layer, thus avoiding the problem of dual half-impulse responses created by interpolation. The second layer of the interpolation deals with the angle-dependent spectrum variations (FIG. 1). This is a multiple-input single-output system (for each channel) which we created in state-space form.

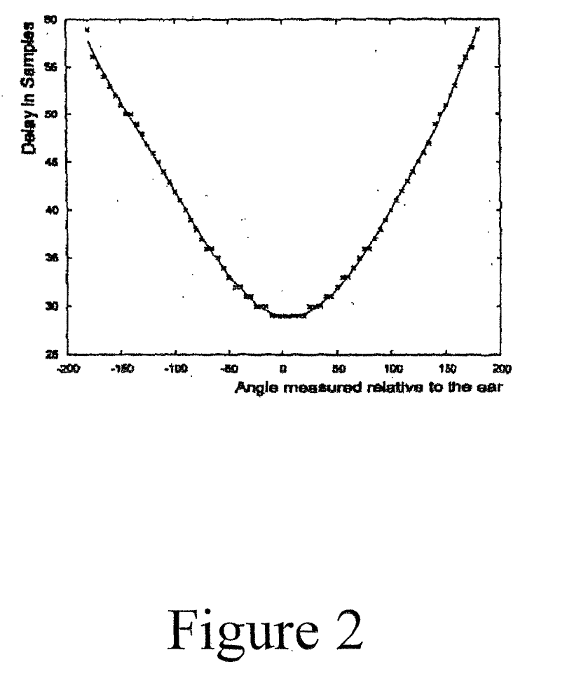

The signal for any angle θ can be fed to the input corresponding to that angle, or if there is no input corresponding to θ then the signal can be split into the two adjacent inputs (or more in the case of both azimuth and elevation variations). In order to proceed with the two-layered model described above, we first extract the delay from the measured impulse responses. FIG. 2 shows the delay extracted from the measurements and fitted with a sixth order polynomial.

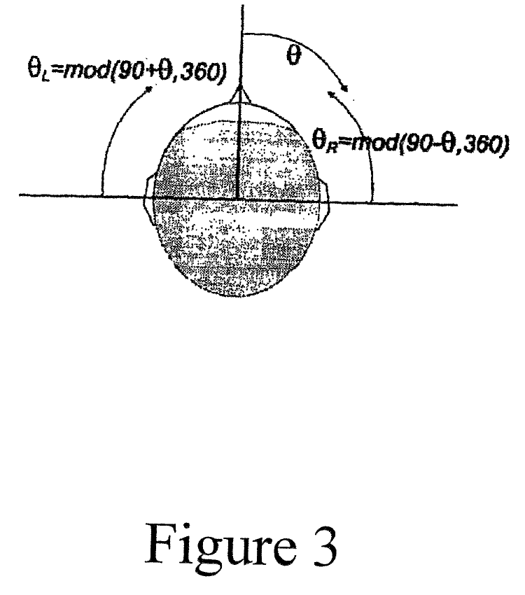

It should be noted that here the azimuth is measured from the center of the head relative to the midcoronal and towards the face as shown in FIG. 3 and not relative to the midsagittal and clockwise as a common practice. For example, the azimuth of 270° relative to the midsagittal corresponds to 180° for the right ear but to 0° for the left ear measured with this proposed convention. This method of representation was chosen because it allows us to use a common delay function for both ears.

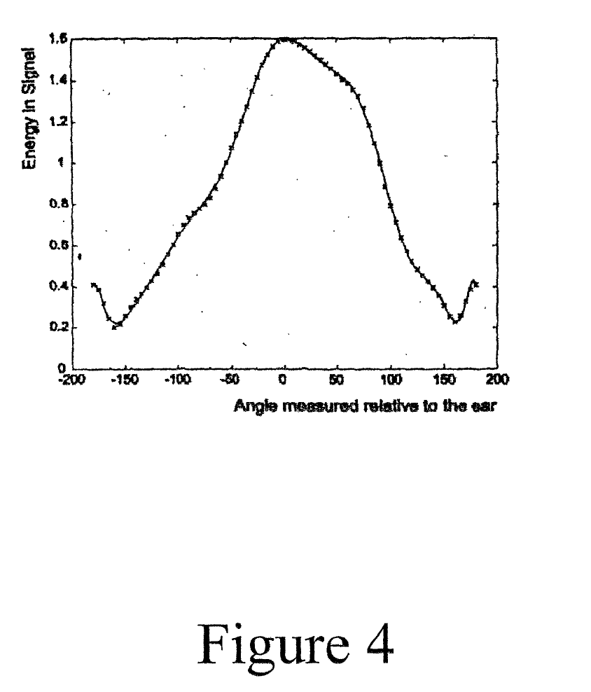

Similarly, we can approximate the gain with a 14th order polynomial as in FIG. 4. The advantages of polynomial fitting are not so obvious when only one elevation is considered, but become more evident when the entire 3-D space is taken into consideration.

The measurements used in this paper include impulse responses taken using a KEMAR dummy head. These 512-point impulse responses can be used as an FIR model against which our comparisons will be based. A one input-one output case is briefly described below.

Consider an impulse response model of a causal, stable, multivariable and linear time-invariant system. If the system state space model is

x(n+1)=Ax(n)+Bu(n)

y(n)=Cx(n)+Du(n)

and an impulse is applied to the system then (assuming that u₀=1, without loss of generality):

y₀=D

x₁=B y₁=CB

x₂=AB y₂=CAB

x₃=A²B y₂=CA²B

. . . . . .

. . . . . .

x_{N}=A^{N}B y_{N}=CA^{N}B

Forming the above into a matrix:

$$[ \begin{matrix}y ( n ) \\ y ( n + 1 ) \\ y ( n + 2 ) \\ ⋮\end{matrix} ] = [ \begin{matrix}CB & CAB & {CA}^{2} B & ⋯ \\ CAB & {CA}^{2} B & {CA}^{3} B & ⋯ \\ {CA}^{2} B & {CA}^{3} & ⋯ & ⋯ \\ {CA}^{3} B & {CA}^{4} B & ⋯ & ⋯ \\ ⋮ & ⋮ & ⋮ & ⋰\end{matrix} ] [ \begin{matrix}u ( n ) \\ 0 \\ ⋮ \\ ⋮\end{matrix} ]$$

Separating the Handel matrix (i.e., the matrix that in position (i, j) is CA^{1-j-1}B) and expressing it in its Singular Value Decomposition (SVD) components:

$$H = [ \begin{matrix}C \\ CA \\ {CA}^{2} \\ ⋮\end{matrix} ] \cdot [ {BABA}^{2} B … ] = WG = {USV}^{T}$$

where U, V are unitary matrices and Σ contains the singular values along its diagonal in decreasing magnitude, i.e.,

Σ=Diag [σ₁, σ₂, σ₃, . . . σᵣ, σᵣ₋₁, . . . σ_{N+1}]

and Ω and Γ are the extended observability and reachability matrices that can be expressed in terms of the SVD components of H as:

$$W = {US}^{\frac{1}{2}} and G = {S}^{\frac{1}{2}} {V}^{T}$$

One way to reduce the model is to use

$$H = [ \begin{matrix}{U}_{n} & \overline{{U}_{n}}\end{matrix} ] \cdot [ \begin{matrix}{S}_{n} & 0 \\ 0 & \overline{{S}_{n}}\end{matrix} ] [ \begin{matrix}{V}_{n} \\ -- - T \\ {V}_{n}\end{matrix} ]$$

and reduce Ω to Γ to:

$${W}_{n} = {U}_{n} {S}_{n}^{\frac{1}{2}} and {G}_{n} = {S}_{n}^{\frac{1}{2}} {V}_{n}^{T}$$

This will give:

$$A = {S}_{-}^{\frac{1}{2}} {U}_{n}^{T} {U}_{n}^{↑} {S}^{\frac{1}{2} } C = {U}_{n}^{1} {S}^{\frac{1}{2}}$$

$$B = {( {S}^{\frac{1}{2}} ( {V}_{n}^{1} ) )}^{T} D = {y}_{0}$$

While there are several definitions for Uₙ and

$${U}^{\frac{↑}{n}} ,$$

one that also guarantees stability is

$${U}_{n} = [ \begin{matrix}{U}_{n}^{1} \\ ⋮ \\ {U}_{n}^{N - 1} \\ {U}^{\frac{N}{n}}\end{matrix} ] and {U}_{n}^{↑} = [ \begin{matrix}{U}_{n}^{2} \\ ⋮ \\ {U}_{n}^{N} \\ O\end{matrix} ]$$

To achieve higher speeds in model creation and the ability to handle any model size. The method is performed on each impulse response separately. This avoids the dimension increase of the Hankel matrix and consequently drops the computational cost of the SVD significantly since SVD is an 0(3) operation. The individual state-space models are combined in a single model to form the final model. Further reduction can be achieved on the resulting model if desired.

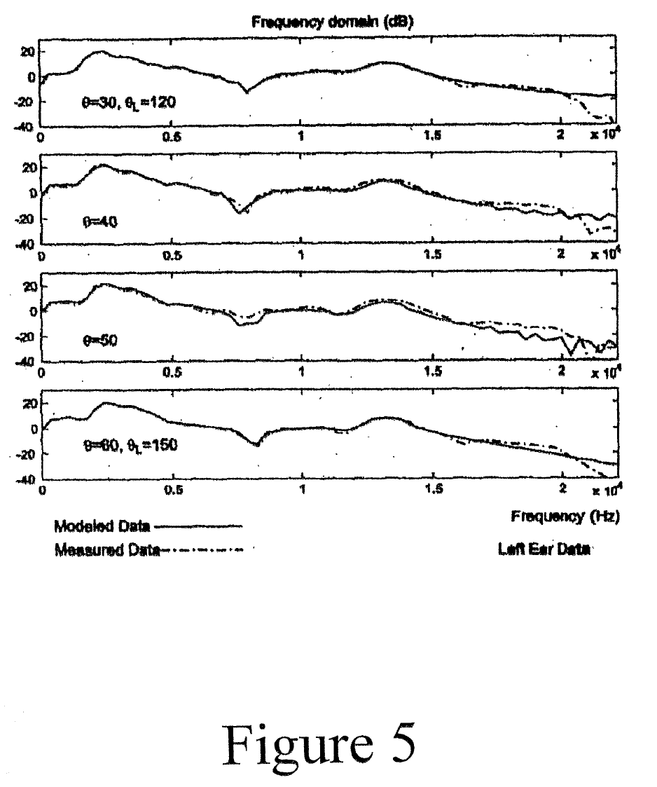

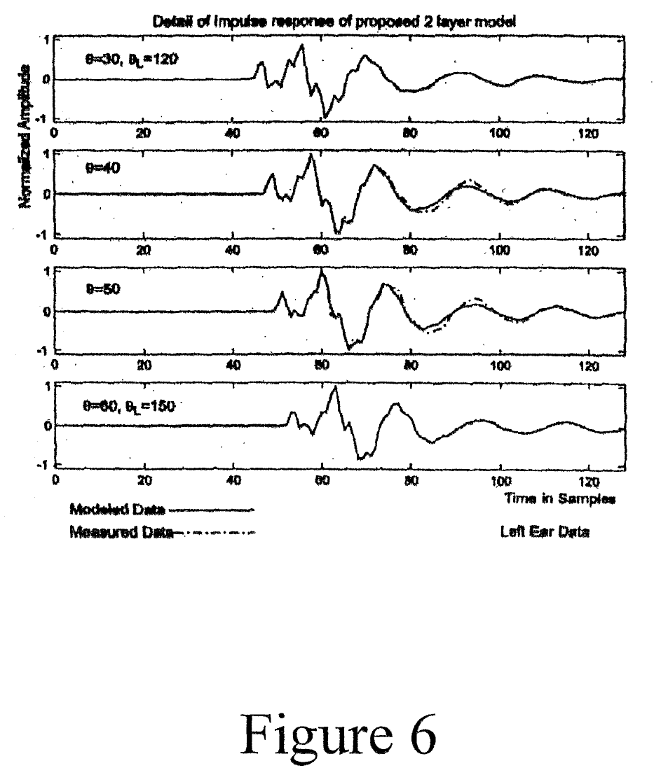

The advantages of the two-layer HRTF model can better be observed by examining a few representative impulse responses. FIGS. 5 and 6 show the measured data with a dashed line and the simulated data with a solid line. The model was created with data measured every 30°, and therefore only data from the first and last plot of each figure were used for the creation of the model. The other two simulated responses in the plot correspond to data synthesized from the 30° and 60° inputs of the state-space model. For example, angle 40° corresponds to ⅔ of the input signal being fed through the 30° input, while the remaining ⅓ is input to the 60° direction. As expected, the two main cues of delay and gain were preserved in the impulse response since they are generated from a separate, very accurate layer. The second layer can then be reduced according to the desired accuracy.

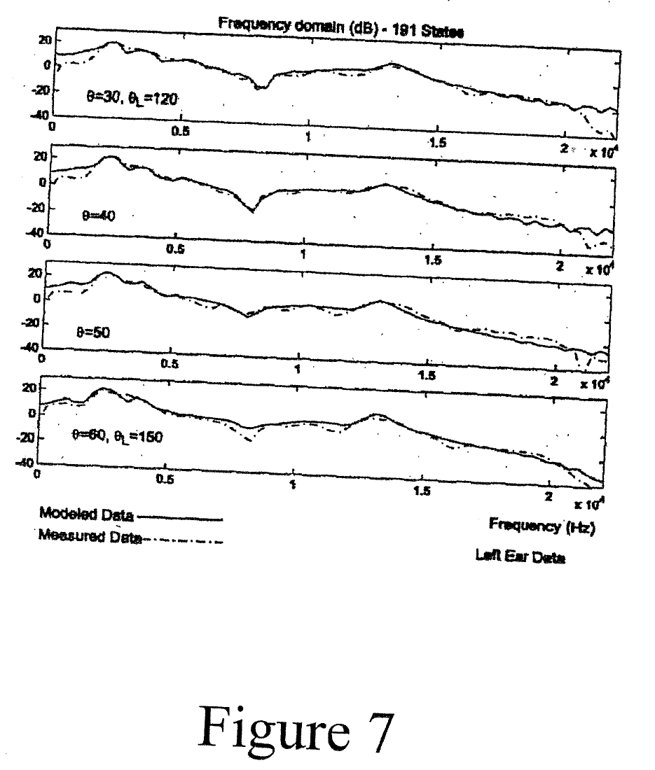

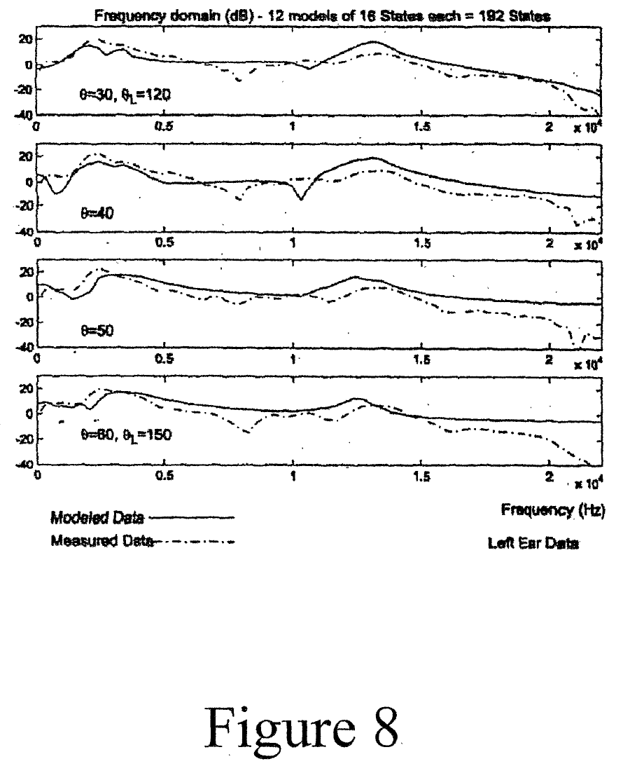

FIG. 7 shows the performance of a further reduced state space model. The model was reduced to less than a third its initial size (down to 191 states from 600). As can be seen from the figures, there was some minor loss of accuracy. FIG. 8 displays the performance of an equivalent model size that was created by reducing each individual HRTF to a 16 state model. These models correspond to a combined model of 192 states that is of equivalent size to the previous combined model but that performs very poorly. The advantage of performing the reduction to the combined invention is clearly evident.

Although the state-space model is computationally expensive compared to an FIR filter, it provides several advantages over the latter while avoiding some of the disadvantages of IIR filters. Recent advances in FPGA technology allow large matrix multiplications at very high speeds that would make construction of a larger size state-space device possible. Others consider N×N times N×N matrix multiplication, which can be extended to N×N times N×1 multiplication (the most expensive operation in the state space representation). N can be given by:

$$\frac{{N}^{2}}{p \times {f}_{FPGA}} < \frac{1}{44.1 kHz}$$

for a signal sampled at 44.1 kHz, where f_{FPGA} is the FPGA clock frequency and p is the number of parallel multipliers.

Today's FPGA's with speeds exceeding 150 MHz and p>100 can easily handle state-space models of more than 500 states built on a single FPGA. As technology in this field is advancing with the System On a Chip model rapidly gaining ground, it will not be long before state-space models of more than a thousand states can be calculated in real time.

Another advantage that comes with the use of a state-space device is memory, which eliminates the audible “clicking” noise heard when changing from filter to filter. In fact, a model with many states eliminates the need for interpolation due to the memory. Interpolation, by passing a signal to two inputs at once, is however desirable to avoid sudden jumps in space of the virtual source.

Finally, we have demonstrated that while a single model for the whole space can achieve spatial rendering of multiple sources at once, it can also result in a smaller size than the individual models for all directions combined.

What is claimed is:

1. A method for the localization of sound in three dimensional space comprising measuring the variations which arise from reflections and diffraction effects from pinnae and creating a state space model to synthesize a filter at any position.

2. The method as claimed in claim 1, wherein the pinnae are calculated by measuring a set of head related transfer functions which correspond to an azimuth and an elevation angle for an ear.

3. The method as claimed in claim 1, wherein the state space model is used to synthesize multiple head-related transfer function filter simultaneously for multiple angles around the listener.

4. The method as claimed in claim 1, wherein the state space model is used to synthesize multiple moving sound sources that retain a correct head-related transfer function characteristics at each position in their path of motion.

5. The method as claimed in claim 1, wherein the state space model is used to synthesize correct head-related transfer functions as a listener's head moves.
